(19) United States
(12) Patent Application Publication
(10) Pub. No.: US 2006/0257719 A1
(43) Pub. Date: Nov. 16, 2006

(54) Catalyst for fuel cell electrode

(76) Inventors: Belabbes Merzougui, Warren, MI (US); Michael K. Carpenter, Troy, MI (US); Swathy Swathirajan, West Bloomfield, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/431,979

(22) Filed: May 11, 2006

Related U.S. Application Data
(60) Provisional application No. 60/681,344, filed on May 16, 2005.

(51) Int. Cl. H01M 4/86; H01M 8/10; H01M 4/90; H01M 4/96

(52) U.S. Cl. 429/44; 429/30

(57) ABSTRACT

The durability of a PEM fuel cell is improved by replacing carbon catalyst support materials in the cathode (and optionally both electrodes) with a titanium oxide support. The electrode thus preferably contains noble metal containing catalyst particles carried on catalyst support particles of titanium oxide. The catalyst-bearing titanium oxide particles are mixed with electrically conductive material such as carbon particles. The combination of platinum particles deposited on titanium dioxide support particles and mixed with conductive carbon particles provides an electrode with good oxygen reduction capacity and corrosion resistance in an acid environment.

### CROSS-REFERENCE TO RELATED APPLICATION

This application claims the benefit of U.S. Provisional Application 60/681,344 filed May 16, 2005 and titled “Catalyst for Fuel Cell Electrode”.

### TECHNICAL FIELD

This invention pertains to fuel cells such as ones employing a solid polymer electrolyte membrane in each cell with catalyst containing electrodes on each side of the membrane. More specifically, this invention pertains to electrode members for such electrode/electrolyte membrane assemblies where the electrodes include a mixture of (i) metal catalyst particles deposited on metal oxide support particles and (ii) an electrically conductive high surface area material.

### BACKGROUND OF THE INVENTION

Fuel cells are electrochemical cells that are being developed for motive and stationary electric power generation. One fuel cell design uses a solid polymer electrolyte (SPE) membrane or proton exchange membrane (PEM), to provide ion transport between the anode and cathode. Gaseous and liquid fuels capable of providing protons are used. Examples include hydrogen and methanol, with hydrogen being favored. Hydrogen is supplied to the fuel cell's anode. Oxygen (as air) is the cell oxidant and is supplied to the cell's cathode. The electrodes are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote ionization of hydrogen at the anode and reduction of oxygen at the cathode. Protons flow from the anode through the ionically conductive polymer membrane to the cathode where they combine with oxygen to form water, which is discharged from the cell. Conductor plates carry away the electrons formed at the anode.

Currently, state of the art PEM fuel cells utilize a membrane made of one or more perfluorinated ionomers such as DuPont's Nafion®. The ionomer carries pendant ionizable groups (e.g. sulfonate groups) for transport of protons through the membrane from the anode to the cathode.

A significant problem hindering the large-scale implementation of fuel cell technology is the loss of performance during extended operation, the cycling of power demand during normal automotive vehicle operation as well as vehicle shut-down/start-up cycling. This invention is based on the recognition that a considerable part of the performance loss of PEM fuel cells is associated with the degradation of the oxygen reduction electrode catalyst. This degradation is probably caused by a combination of mechanisms that alter the characteristics of the originally prepared catalyst and its support. Likely mechanisms include growth of platinum particles, dissolution of platinum particles, bulk platinum oxide formation, and corrosion of the carbon support material. Indeed, carbon has been found to corrode severely at electrical potentials above 1.2 volts and the addition of platinum particles onto the surface of the carbon increases the corrosion rate of carbon considerably at potentials below 1.2 volts. These processes lead to a loss in active surface area of the platinum catalyst that leads to loss in oxygen electrode performance. However, electrochemical cycling experiments have revealed that the loss of hydrogen adsorption area alone cannot explain the loss in oxygen performance. Additional factors include interference from adsorbed hydroxyl (OH) species and a possible place-exchange of adsorbed OH species that can alter the electrocatalytic properties of the platinum catalyst towards oxygen reduction. Thus, the specific interaction of platinum with the catalyst support can have an influence on the stability of performance of the platinum electrocatalyst.

It is desirable to provide a more effective and durable catalyst and catalyst support particle combination for use in electrodes of fuel cells.

### SUMMARY OF THE INVENTION

In accordance with a preferred embodiment of the invention, nanometer size particles of a noble metal, or an alloy including a noble metal, are deposited on titanium dioxide support particles that are found to provide corrosion resistance in, for example, the acidic or alkaline environment of the cell. The catalyst-bearing titanium dioxide support particles are mixed with an electronically conductive, high surface area material, such as carbon, and the mixture is used as an electrode material in the fuel cell. Physico-chemical interactions between the metal catalyst nanoparticles and the titanium dioxide support particles serve to better stabilize the electrocatalyst against electrochemical degradation and can improve oxygen reduction performance. Also, in the case where carbon is used as the conductive material, the lack of direct contact between the particles of carbon and particles of catalyst metal helps reduce the corrosion rate of carbon in the fuel cell operating potential range, thus enhancing the electrode stability.

In one example, platinum is chemically deposited onto relatively high surface area titania (TiO₂) particles. Such a catalyst is useful, for example, as an oxygen reduction catalyst in a low temperature (<200° C.) hydrogen/oxygen fuel cell using a proton conductive polymer membrane that is, for example, an ionomer like Nafion® with pendant sulfonate groups. The platinized titania particles are mixed with carbon particles to form an electrocatalyst. This method differs from previous approaches since it deliberately isolates the carbon particles from the active platinum catalyst particles. The mixture of particles may also be mixed with a polymeric binder material similar in composition to the electrolyte membrane material.

Thus, the membrane electrode assembly in each cell of a hydrogen-oxygen fuel cell stack would include a suitable proton exchange membrane with a thin hydrogen oxidation anode on one side and an oxygen reduction cathode on the other side. In at least the cathode, or in both electrodes, the catalyst is supported on particles of the corrosion-resistant titanium dioxide. The supported catalyst particles are intimately mixed with conductive material such as carbon particles. It is preferred that the titanium dioxide be prepared as relatively high surface area particles (for example, 50 m²/g or higher). It is also preferred that the particles have a diameter or largest dimension that is less than about 200 nm.

The use of titanium dioxide catalyst support particles is applicable in acid or alkaline cells that have relatively low operating temperatures, for example, less than about 200° C. The supported catalysts will include noble metals, alloys of noble metals with non-noble metals, and non-noble metal catalysts.

Other objects and advantages of the invention will become apparent from a detailed description of exemplary preferred embodiments which follow.

### BRIEF DESCRIPTION OF THE DRAWINGS

FIG. 1 is a schematic view of a combination of solid polymer membrane electrolyte and electrode assembly (MEA) used in each cell of an assembled fuel cell stack.

FIG. 2 is an enlarged fragmentary cross-section of the MEA of FIG. 1.

FIGS. 3A and 3B are cyclic voltammograms. FIG. 3A is a graph of current density J(mA/cm²) vs. voltage response (E/V) for a commercial platinum-on-carbon (Vulcan carbon, Vu) benchmark catalyst after 50 potentiodynamic cycles (dashed line) and 1000 potentiodynamic cycles (solid line) between 0 and 1.2 V (reversible hydrogen electrode, RHE) at 20 mV/s in 0.1 M HClO₄ at a thin film disk electrode.

FIG. 3B is a graph of current density J(mA/cm²) vs. voltage response for a platinum-on-TiO₂ catalyst, mixed with conductive carbon particles (Vu) of this invention, designated PT1-Vu, after 50 (dashed line) and 1000 potentiodynamic cycles (solid line) between 0 and 1.2 V (reversible hydrogen electrode, RHE) at 20 mV/s in 0.1 M HClO₄ at a thin-film disk electrode.

FIG. 4A is a graph of remaining hydrogen adsorption area (HAD) in terms of m²/g of platinum versus number of potentiodynamic cycles for a commercial platinum-on-carbon benchmark catalyst (filled diamonds, Pt/Vu, 47.7% platinum) and a platinum-on-TiO₂ catalyst, mixed with conductive carbon particles, of this invention (filled squares, PT1,Pt/TiO₂+Vu). The potentiodynamic cycling was between 0 and 1.2 V (reversible hydrogen electrode, RHE) in 0.1 M HClO₄ at 20 mV/s and using a thin-film disk electrode.

FIG. 4B is a graph of normalized HAD area versus number of potentiodynamic cycles for a commercial platinum-on-carbon benchmark catalyst (filled squares, Pt/Vu) and a platinum-on-TiO₂ catalyst (plus carbon particles) of this invention (filled diamonds), designated PT1, Pt/TiO₂+Vu. Normalization was done with respect to the maximum HAD areas obtained for each electrode. The potentiodynamic cycling was between 0 and 1.2 V (reversible hydrogen electrode, RHE) in 0.1 M HClO₄ at 20 mV/s and using a thin-film disk electrode.

FIG. 5A is a graph of the oxygen reduction responses (ORR) from two thin-film rotating disk electrodes; one a commercial platinum-on-Vulcan carbon benchmark catalyst (dashed line, Pt/Vu) and the other a platinum-on-TiO₂ catalyst (plus Vulcan carbon particles) of this invention (solid line, PT1, Pt/TiO₂+Vu). The platinum loading was about 150 micrograms per square centimeter. The data is plotted as current density (mA/cm²) versus voltage with respect to reversible hydrogen electrode (RHE). The potentiodynamic cycling was between 0 and 1.2 V (vs. RHE) at 20 mV/s and using a thin film disk electrode rotating at 400 rpm in an oxygen-saturated solution of 0.1 M HClO₄ at 25° C. The oxygen response traces shown in the figure were for the 50^{th} cycle and were taken in the same solution at 1600 rpm, 10 mV/s and 25° C.

FIG. 5B is a graph showing the effect of electrical potential cycling on the ORR half-wave potential (E_{1/2}) of oxygen reduction for a commercial platinum-on-Vulcan carbon benchmark catalyst (filled diamonds, Pt/Vu) and a platinum-on-TiO₂ catalyst (plus Vulcan carbon particles) of this invention (filled triangles, PT1, Pt/TiO₂+Vu). The half-wave potential is the potential at which the oxygen reduction current is one-half of the mass-transport limited current. The potentiodynamic cycling was between 0 and 1.2 V (reversible hydrogen electrode, RHE) at 20 mV/s and using a thin-film disk electrode rotating at 400 rpm in an oxygen-saturated solution of 0.1 M HClO₄ at 25° C. The oxygen response conditions were measured in the same solution at 1600 rpm, 10 mV/s and 25° C.

### DESCRIPTION OF EXEMPLARY PREFERRED EMBODIMENTS

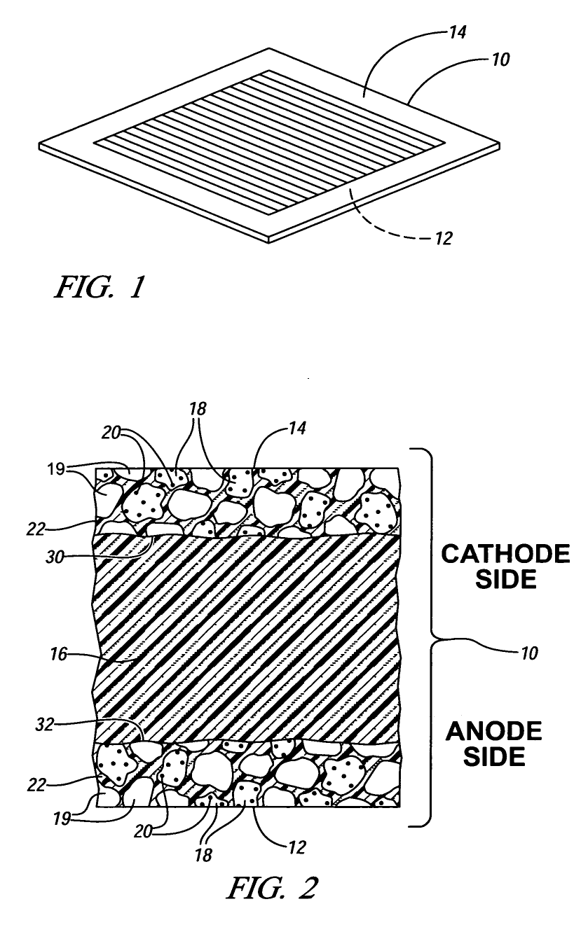

Many United States patents assigned to the assignee of this invention describe electrochemical fuel cell assemblies having an assembly of a solid polymer electrolyte membrane and electrode assembly. For example, FIGS. 1-4 of U.S. Pat. No. 6,277,513 include such a description, and the specification and drawings of that patent are incorporated into this specification by reference.

FIG. 1 of this application illustrates a membrane electrode assembly 10 which is a part of the electrochemical cell illustrated in FIG. 1 of the '513 patent. Referring to FIG. 1 of this specification, membrane electrode assembly 10 includes anode 12 and cathode 14. In a hydrogen/oxygen (air) fuel cell, for example, hydrogen is oxidized to H⁺ (proton) at the anode 12 and oxygen is reduced to water at the cathode 14.

FIG. 2 provides a greatly enlarged, fragmented, cross-sectional view of the membrane electrode assembly shown in FIG. 1. In FIG. 2, anode 12 and cathode 14 are applied to opposite sides (sides 32, 30 respectively) of a proton exchange membrane 16. PEM 16 is suitably a membrane made of a perfluorinated ionomer such as DuPont's Nafion®. The ionomer molecules of the membrane carry pendant ionizable groups (e.g. sulfonate groups) for transport of protons through the membrane from the anode 12 applied to the bottom surface 32 of the membrane 16 to the cathode 14 which is applied to the top surface 30 of the membrane 16. In an exemplary cell, the polymer electrolyte membrane 16 may have dimensions of 100 mm by 100 mm by 0.05 mm. As will be described, the anode 12 and cathode 14 are both thin, porous electrode members prepared from inks and applied directly to the opposite surfaces 30, 32 of the PEM 16 through decals.

In accordance with this invention, cathode 14 suitably includes nanometer size, acid insoluble, titanium dioxide catalyst support particles 18. Nanometer size includes particles having diameters or largest dimensions in the range of about 1 to about 200 nm. The titanium dioxide catalyst support particles 18 carry smaller particles 20 of a reduction catalyst for oxygen, such as platinum. The platinized titanium oxide support particles 18 are intimately mixed with electrically conductive, matrix particles 19 of, for example, carbon. Both the platinized titanium oxide support particles 18 and the electron conductive carbon matrix particles 19 are embedded in a suitable bonding material 22. In this embodiment, the bonding material 22 is suitably a perfluorinated ionomer material like the polymer electrolyte membrane 16 material. The perfluorinated ionomer bonding material 22 conducts protons, but it is not a conductor of electrons. Accordingly, a sufficient amount of electrically conductive, carbon matrix particles are incorporated into cathode 14 so that the electrode has suitable electrical conductivity.

A formulated mixture of the platinum particle 20—bearing titanium dioxide catalyst support particles 18, electrically conductive carbon matrix particles 19, and particles of the electrode bonding material 22 is suspended in a suitable volatile liquid vehicle and applied to surface 30 of proton exchange membrane 16. The vehicle is removed by vaporization and the dried cathode 14 material further pressed and baked into surface 30 of PEM 16 to form cathode 16.

In contrast to prior art membrane electrode assemblies, assembly 10 contains platinum catalyst 20 supported on electrically-resistive, nanometer size, high surface area titanium dioxide particles rather than on carbon support particles. However, electrical conductivity in cathode 16 is provided by carbon particles 19 or particles of another suitable durable and electrically conductive material. In the FIG. 2 embodiment of the invention, the anode 12 is constructed of the same materials as cathode 14. But anode 12 may employ carbon support particles or matrix particles, or a different combination of conductive matrix particles and corrosion-resistant metal oxide catalyst support particles.

As stated, the preferred electrode catalysts for hydrogen-oxygen cells using a proton exchange membrane are noble metals such as platinum and alloys of noble metals with transition metals such as chromium, cobalt, nickel and titanium. The titanium dioxide particles provide physico-chemical interaction with the intended catalyst metal, metal alloy or mixture and durability in the acidic or alkaline environment of a cell. Preferably, the titanium oxide particles have a surface area of about 50 m²/g. And preferably, the titanium oxide particles have a diameter of largest dimension below about 200 nm.

Experimental

In one example, platinum is chemically deposited onto titania (TiO₂) and subsequently mixed with carbon particles to form an electrocatalyst. Specifically, nanoparticles of platinum can be deposited from a solution of chloroplatinic acid by reduction with hydrazine hydrate in the presence of carbon monoxide. The presence of titania in the deposition solution insures that Pt nanoparticles will be deposited on the titania.

In an illustrative experiment, 2.1 g of H₂PtCl₆ was dissolved in 350 ml water. 1.2 g of titania (having a surface area of ˜50 m²/g) was added to the solution and the pH was adjusted to 5 with 1 M NaOH. The mixture was sonicated for 15 minutes, then carbon monoxide gas was bubbled through the mixture at 300 sccm to saturate the solution with CO. 0.26 g of hydrazine hydrate was dissolved in 5 ml H₂O and this reducing solution was added drop wise to the titania/chloroplatinic acid mixture. The reaction mixture was stirred and the flow of CO continued to be bubbled through the mixture for one hour. The CO flow was then reduced to 50 sccm and stirring was continued for another 16 hours. The product was filtered and washed repeatedly with H₂O. The product was first air-dried, then dried at room temperature under vacuum. The platinum content of the Pt/TiO₂ supported catalyst was 32% by weight.

To make an effective electrocatalyst for a fuel cell application, a conductive carbon, such as commercially available Vulcan XC-72, was mixed with the Pt/titania material in a 5:1 water/isopropanol solution to form an ink. The liquid-solids ink mixture was subjected to ultrasonic vibrations for a period of about 30 min. An increase in the duration of ultrasonic treatment had the effect of increasing the hydrogen adsorption area (HAD) of the platinized titanium dioxide and carbon electrocatalyst.

Electrode films of the platinum-on-titania/carbon inks were formed on rotatable electrode disks of glassy carbon for assessment of electrode performance as an oxygen reduction catalyst in an electrochemical cell containing 0.1 M HClO₄. A commercial platinum-on-carbon material (47.7% by weight platinum), such as is presently used in hydrogen/oxygen PEM cells, was obtained as a benchmark electrode material. The carbon catalyst support particles provided suitable electrical conductivity for the electrode material. An ink of this benchmark material was likewise applied to rotatable electrode disks. The platinum loading for each set of disks was the same, about 0.15 mg Pt per square centimeter of disk area.

These benchmark and Pt/TiO₂/C electrode catalysts were evaluated for hydrogen adsorption (HAD) area behavior and for oxygen reduction performance as a function of potential cycling using a thin-film rotating disk electrode method.

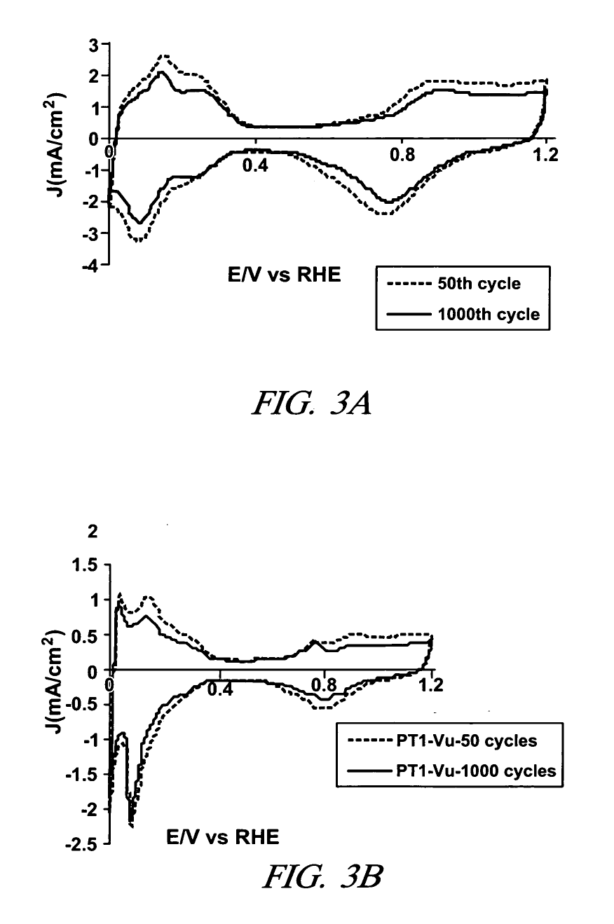

Testing demonstrated that the deposition of Pt on TiO₂ by wet chemistry, as described above, leads to a supported electrode catalyst where the Pt interacts strongly with the oxygen of TiO₂ and as a result, the adsorption of OH residue on Pt is weakened or reduced. This is demonstrated in the current-voltage response shown in FIG. 3A (the benchmark platinum-on-carbon catalyst) and FIG. 3B (PT1-Vu, which is the Pt/TiO₂ catalyst with a conductive matrix of Vulcan carbon particles).

Cyclic voltammograms (CV) shown in FIGS. 3A and 3B were obtained with a three-electrode cell in 0.1 M HClO₄. The working electrode was a glassy carbon rotatable disk electrode with a thin film of the catalyst material applied on the surface using an ink coating method. The counter electrode was a platinum wire and the reference electrode was a Pt-based hydrogen electrode in a hydrogen-saturated 0.1 M perchloric acid solution. The working electrode potential was cycled between 1.2 V and 0 V versus the hydrogen reference electrode, and the current-voltage response was recorded after various cycling periods with the solution de-aerated by bubbling argon.

In the absence of oxygen, the CV behavior illustrates the adsorption characteristics of the catalyst; specifically, interactions with chemisorbed H and OH species, that are crucial in determining the activity for oxygen reduction. Chemisorbed hydrogen which determines the HAD area is obtained from the absorbed hydrogen charge seen in the potential region 0-0.35 V, while the adsorbed OH charge is obtained from the cathodic reduction peak observed in the range of 0.6-0.9 V. Thus, the ratio of PtOH charge to HAD charge is typically 1.0-1.5 for the benchmark catalyst, but can be as low as 0.25 for the Pt/TiO₂/carbon matrix electrode catalyst of this invention. This result confirms the strong interaction between Pt and TiO₂ that considerably weakens the interaction of Pt with water molecules. This type of interaction could not be obtained by depositing the Pt catalyst on a mixture of TiO₂ and carbon, or by depositing Pt on carbon and then mixing with TiO₂, as attempted by previous workers. It is important to note that CV data for standard Pt and Pt alloy fuel cell catalysts on carbon supports always indicates significant Pt—OH formation.

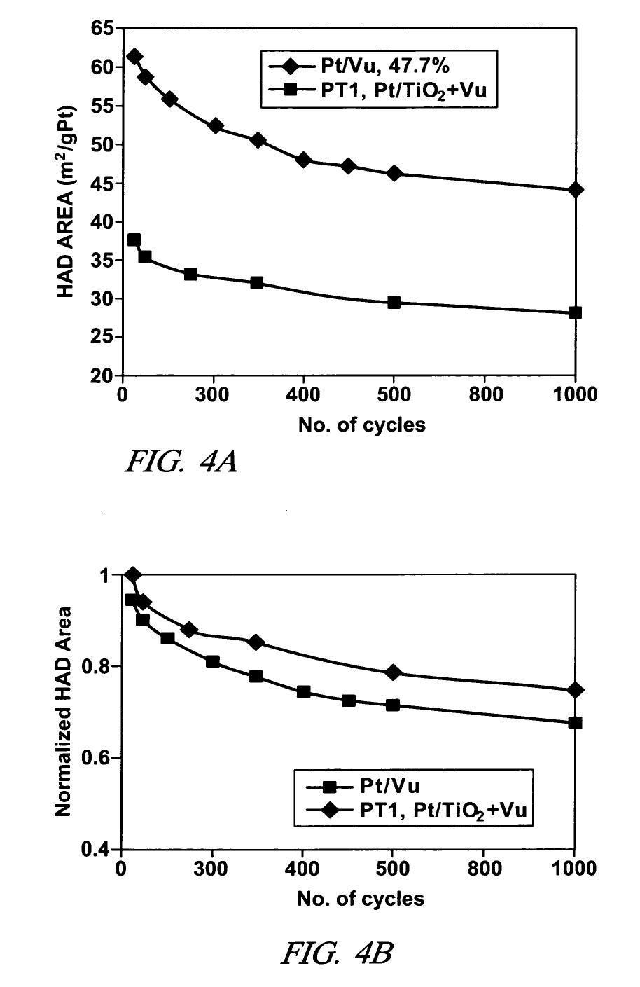

The decrease in HAD area with cycling is shown in FIG. 4A for the two catalysts and the normalized HAD area losses are shown in FIG. 4B. These plots show the increased stability of the HAD area for the catalyst of this invention due to the strong interaction of Pt with TiO₂, and by the separation of platinum particles from carbon during the catalyst preparation method of this invention, as noted earlier. The experimental setup for FIGS. 4A and 4B are the same as for FIGS. 3A and 3B.

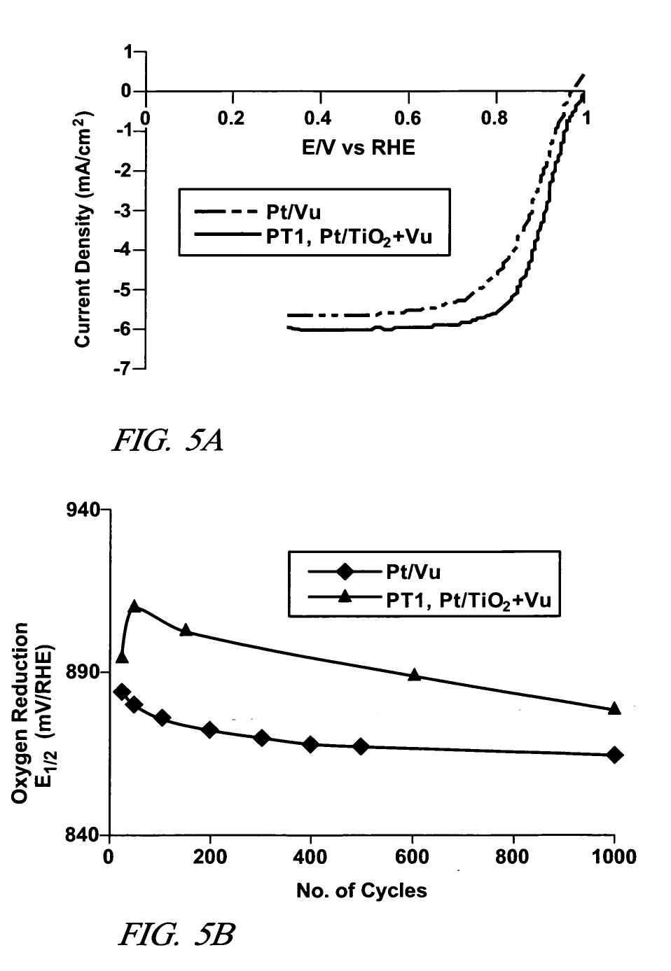

Oxygen reduction behavior is shown in FIG. 5A for the benchmark catalyst and the metal oxide supported catalyst illustrative of this invention at various stages in the potential cycling of the electrodes. The current-voltage curves for oxygen reduction were obtained using the experimental set up described for FIGS. 3A and 3B. To record an oxygen reduction response, the cycling of the electrode in the oxygen-saturated electrolyte was stopped, the potential shifted to 1 V (vs. RHE), and the working electrode potential was cycled between 0 V and 1 V at a scan rate of 10 mV/s while rotating the disk at 1600 rpm. The current-voltage responses for selected positive-going scans are shown in FIG. 5A. Superior oxygen reduction catalytic electrodes maintain higher current density values as the voltage versus RHE is increased. The CV response for Pt/TiO₂—C is clearly superior to Pt/C after 50 cycles.

The oxygen reduction half-wave potentials (E_{1/2}) for other selected areas are plotted in FIG. 5B for each selected scan. Both the apparent and specific activities for oxygen reduction are higher for the catalyst of this invention even after cycling. FIG. 5B shows the shift in oxygen E_{1/2} potential due to the potentiodynamic cycling in the presence of oxygen. Even after 1000 cycles, the subject Pt/TiO₂ catalyst retained a higher performance over the benchmark Pt/C catalyst.

The combination of platinum on titanium dioxide in a carbon matrix as a fuel cell electrode has been described for illustrating a practice of the invention. But the use of catalyst metals generally on non-conductive metal oxides is within the scope of this invention. Preferred catalyst metals are the noble metals such as platinum or palladium and alloys of such metals with transition metals such as chromium, cobalt, nickel, and titanium. The catalyst support material is a corrosion-resistant metal oxide stable in an acid or alkaline environment as necessary. The metal oxide supported catalyst is used in a mixture with particles of an electrically conductive material such as carbon.

The invention is useful in acid and alkaline fuel cells operating at temperatures less than about 200° C.

1. An acid or alkaline fuel cell for operation at a temperature no higher than about 200° C. and comprising:
a polymer electrolyte membrane sandwiched between an anode and an oxygen-reducing cathode;
the cathode, and optionally the anode, comprising particles of a metal catalyst carried on electrically non-conductive particles of titanium oxide, the particles of titanium oxide being mixed with an electrically conductive material, the electrically conductive material not being in contact with the particles of metal catalyst.

2. A fuel cell as recited in claim 1 in which the titanium oxide catalyst support particles have a surface area of about 50 m²/g or higher.

3. A fuel cell as recited in claim 1 in which the catalyst metal comprises a noble metal.

4. A fuel cell as recited in claim 1 in which the catalyst metal contains a noble metal or an alloy of a noble metal with one or more transition group metals.

5. A fuel cell as recited in claim 1 in which the catalyst metal contains a noble metal or an alloy of a noble metal with one or more transition group metals selected from the group consisting of chromium, cobalt, nickel, or titanium.

6. A fuel cell as recited in claim 1 in which the conductive material comprises carbon.

7. A fuel cell comprising:
a polymer electrolyte membrane with pendant sulfonate groups on the polymer molecules sandwiched between an anode and a cathode;
the cathode being an oxygen reduction cathode comprising particles comprising a noble metal containing catalyst carried on electrically non-conductive titanium oxide support particles; and the titanium oxide-supported, noble metal-containing catalyst particles being mixed with an electrically conductive material, the catalyst particles not being in contact with the electrically conductive material.

8. A fuel cell as recited in claim 7 in which the catalyst consists essentially of a noble metal or an alloy of a noble metal with one or more transition metals selected from the group consisting of chromium, cobalt, nickel, or titanium.

9. A fuel cell as recited in claim 7 in which the catalyst particles consist essentially of platinum and the electrically conductive material consists essentially of carbon.

10. A fuel cell as recited in claim 7 in which the catalyst particles consist essentially of platinum and the electrically conductive material consists essentially of carbon particles.
